(19) United States
(12) Patent Application Publication
(10) Pub. No.: US 2025/0388153 A1
(43) Pub. Date: Dec. 25, 2025

(54) ARMREST SUPPORT STRUCTURE

(71) Applicant: TACHI-S CO., LTD., Tokyo (JP)

(72) Inventors: Hiroaki Hashi, Tokyo (JP); Takamasa Minakawa, Tokyo (JP); Jyunichi Utsumi, Tokyo (JP)

(73) Assignee: TACHI-S CO., LTD., Tokyo (JP)

(21) Appl. No.: 19/244,085

(22) Filed: Jun. 20, 2025

(30) Foreign Application Priority Data
Jun. 24, 2024 (JP) 2024-101014

(51) Int. Cl. B60N 2/75

(52) U.S. Cl. CPC B60N 2/757

(57) ABSTRACT

The armrest support structure is capable of ensuring an appearance quality on the upper side of a hinge cover and capable of making it less likely for a garment or the like to be caught on said upper side. A reverse flange protruding upward from an upper part of a hinge cover is inserted into an opening and extends along a reverse side of a front surface of a skin material, whereby the reverse flange can restrict recession of the skin material on the upper side of the hinge cover. Therefore, an appearance quality on the upper side of the hinge cover can be ensured, and it can be made less likely for a garment or the like to be caught between the upper side of the hinge cover and the skin material.

### BACKGROUND OF THE INVENTION

### 1. Field of the Invention

The present invention relates to an armrest support structure configured to be provided to a seat back, and in particular, relates to an armrest support structure capable of ensuring the appearance quality of a seat back on the upper side of a hinge cover and capable of making it less likely for a garment or the like to be caught on said upper side.

### 2. Description of the Related Art

Some seats for cars or the like have seat backs on which armrests are rotatably supported. For example, in Japanese Patent Application Laid-Open (kokai) No. 2001-354059, a hinge bracket attached to a side part of a back frame of a seat back protrudes frontward from an opening provided in a front surface of a skin material of the seat back, and an armrest is rotatably supported on the protruding part of the hinge bracket. The hinge bracket is covered by a hinge cover in order to hide this rotating mechanism from, for example, a person seated on the seat.

### SUMMARY OF THE INVENTION

However, when, for example, the seated person or the like recesses the skin material of the seat back on the upper side of the hinge cover in an in-use state where the armrest is tilted frontward, the internal structure of the seat back or the like might become visible through the opening of the skin material, and thus the appearance quality of the seat back might be impaired. In addition, when the shape of the recessed part has returned to the original shape thereof, a garment or the like might be caught between the previously recessed part of the skin material and the hinge cover.

The present invention has been made to solve the above problems, and an object of the present invention is to provide an armrest support structure capable of ensuring the appearance quality of a seat back on the upper side of a hinge cover and capable of making it less likely for a garment or the like to be caught on said upper side.

In order to achieve the object, an armrest support structure according to the present invention allows an armrest to be rotatably supported with respect to a seat back of a seat and includes: a hinge bracket configured to be attached to a side part of a back frame of the seat back, the hinge bracket having a part that allows the armrest to be rotatably supported thereon and that is configured to protrude frontward from an opening provided in a front surface of a skin material of the seat back; a hinge cover configured to be mounted to the hinge bracket protruding from the opening, so as to cover the hinge bracket; and a reverse flange protruding upward from an upper part of the hinge cover, the reverse flange being configured to be inserted into the opening and extend along a reverse side of the front surface of the skin material.

In the armrest support structure according to the first aspect, the reverse flange protruding upward from the upper part of the hinge cover is inserted into the opening and extends along the reverse side of the front surface of the skin material, whereby the reverse flange can restrict recession of the skin material on the upper side of the hinge cover. Therefore, the appearance quality of the seat back can be ensured on the upper side of the hinge cover, and it can be made less likely for a garment or the like to be caught between the upper side of the hinge cover and the skin material.

An armrest support structure according to a second aspect exhibits the following advantageous effects in addition to the advantageous effects exhibited by the armrest support structure according to the first aspect. An obverse flange protruding upward from the upper part of the hinge cover is configured to be superposed on an obverse side of the front surface of the skin material, whereby it can be made easy to hide the opening on the upper side of the hinge cover by the obverse flange. Furthermore, the skin material is sandwiched between the obverse flange and the reverse flange on the upper side of the hinge cover, whereby frontward and backward movements of the sandwiched part of the skin material are restricted. Therefore, a change in the appearance due to the frontward and backward movements can be suppressed, whereby the appearance quality of the seat back can be improved on the upper side of the hinge cover.

An armrest support structure according to a third aspect exhibits the following advantageous effects in addition to the advantageous effects exhibited by the armrest support structure according to the second aspect. The reverse flange protrudes further upward than the obverse flange, whereby the reverse flange can restrict recession of the skin material on the upper side relative to the obverse flange. As a result, the appearance quality at the joint, between the obverse flange and the skin material, on the upper side of the hinge cover can be further improved, and it can be made less likely for a garment or the like to be caught between the obverse flange and the skin material.

An armrest support structure according to a fourth aspect exhibits the following advantageous effects in addition to the advantageous effects exhibited by the armrest support structure according to the first aspect. The hinge cover includes an inner member configured to cover the armrest side (inner side) of the hinge bracket and an outer member configured to cover a side (outer side), of the hinge bracket, opposite to the armrest. Since the inner member is mounted to the hinge bracket while the inner member is being inserted between the inner side of the hinge bracket and the armrest, the degree of freedom in the manner of movement of the inner member during the mounting is low. Thus, in a case where the reverse flange is provided to this inner member, it is difficult to move the inner member so as to further insert the reverse flange into the opening during the mounting.

Meanwhile, the armrest is absent on the outer side of the hinge bracket. Consequently, in a case where the reverse flange protrudes upward from an upper part of the outer member, the outer member can be easily mounted to the hinge bracket by: inserting the reverse flange into the opening; and then covering the hinge bracket by the outer member from the outer side. Therefore, even though the reverse flange is present, it can be made easy to mount the hinge cover to the hinge bracket.

An armrest support structure according to a fifth aspect exhibits the following advantageous effects in addition to the advantageous effects exhibited by the armrest support structure according to the fourth aspect. An obverse flange protruding upward from an upper part of the inner member is configured to be superposed on an obverse side of the front surface of the skin material, whereby it can be made easy to hide the opening on the upper side of the hinge cover by the obverse flange. Furthermore, the skin material is sandwiched between the obverse flange and the reverse flange on the upper side of the hinge cover, whereby frontward and backward movements of the sandwiched part of the skin material are restricted. Therefore, a change in the appearance due to the frontward and backward movements can be suppressed, whereby the appearance quality can be improved. In addition, the obverse flange and the reverse flange protrude from different members (the inner member and the outer member), whereby it can be made easy to sandwich the skin material between these flanges during mounting of the hinge cover.

An armrest support structure according to a sixth aspect exhibits the following advantageous effects in addition to the advantageous effects exhibited by the armrest support structure according to the fourth aspect. The inner member includes an outer peripheral edge portion configured to protrude toward the outer member so as to cover a periphery of the hinge bracket. The outer member includes an inner peripheral edge portion configured to protrude toward the inner member, the inner peripheral edge portion being configured to be superposed on the hinge bracket side of the outer peripheral edge portion and be fitted and fixed to the outer peripheral edge portion. When the outer member is mounted to the hinge bracket, the outer member is easily shifted backward with respect to the inner member mounted to the hinge bracket, owing to work for inserting the reverse flange into the opening. Consequently, the inner peripheral edge portion of the outer member is easily located on the back side relative to the outer peripheral edge portion of the inner member. The inner peripheral edge portion only has to be fitted and fixed to the outer peripheral edge portion with this positional relationship being maintained, whereby workability in the fitting and fixation can be improved.

### BRIEF DESCRIPTION OF THE DRAWINGS

FIG. 1 is a front view of a seat provided with an armrest support structure according to an embodiment.

FIG. 2 is a side view of a seat back and an armrest as seen in the direction of an arrow II in FIG. 1.

FIG. 3 is a cross-sectional view, of the seat back and the armrest, taken at a line III-III in FIG. 2.

FIG. 4A is a side view of a hinge bracket and an inner member.

FIG. 4B is a front view of the hinge bracket and the inner member.

FIG. 5A is a side view of the hinge bracket and an outer member.

FIG. 5B is a front view of the hinge bracket and the outer member.

FIG. 6 is a cross-sectional view, of the seat back and the armrest, taken at a line VI-VI in FIG. 1.

### DESCRIPTION OF THE PREFERRED EMBODIMENTS

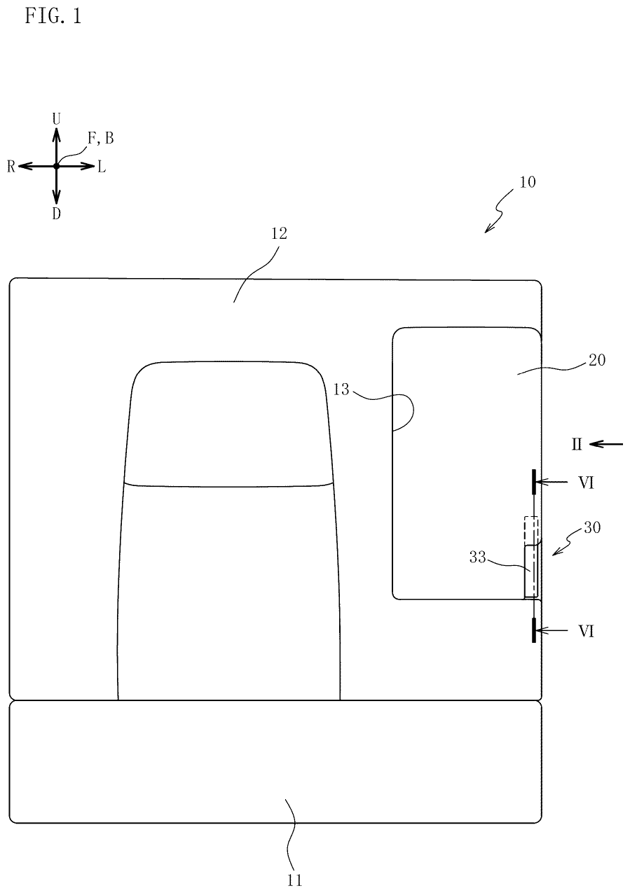

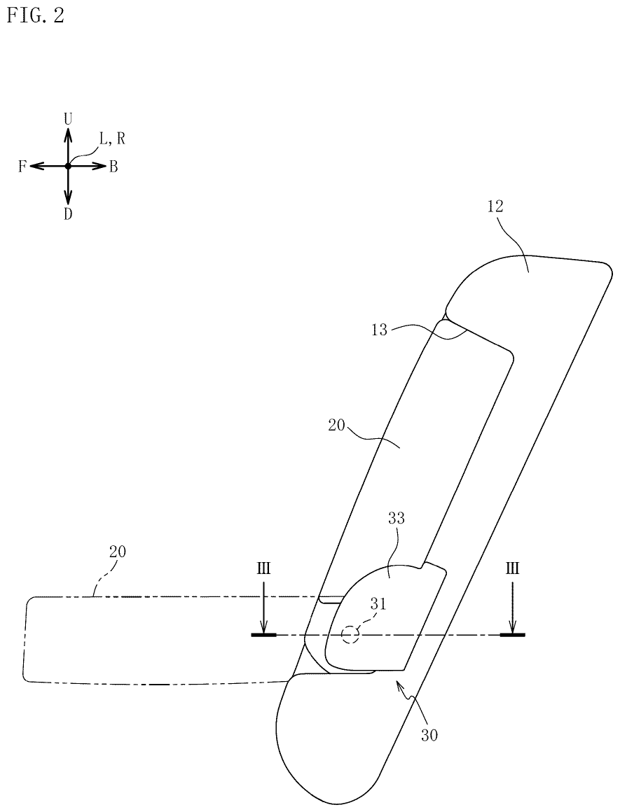

Hereinafter, a preferred embodiment of the present invention will be described with reference to the accompanying drawings. FIG. 1 is a front view of a seat 10 provided with an armrest support structure 30 according to the embodiment. FIG. 2 is a side view of a seat back 12, an armrest 20, and the armrest support structure 30 as seen in the direction of an arrow II in FIG. 1. In FIG. 1, a part of the armrest support structure 30 hidden by the seat back 12 is indicated by a broken line. In each of the drawings, the direction of an arrow U, the direction of an arrow D, the direction of an arrow L, the direction of an arrow R, the direction of an arrow F, and the direction of an arrow B respectively indicate an upward direction, a downward direction, a leftward direction, a rightward direction, a frontward direction, and a backward direction of the seat 10. These directions are identical to respective directions as seen from a person seated on the seat 10.

The seat 10 is a seat mounted in a car (e.g., an automobile). The seat 10 mainly includes: a seat cushion 11 forming a seating surface; the seat back 12 rotatably supported on the seat cushion 11 and forming a backrest; the armrest 20 capable of forming a rest for an arm; and the armrest support structure 30 which allows the armrest 20 to be rotatably supported with respect to the seat back 12.

The seat cushion 11 in the present embodiment forms seating surfaces, for two persons, of a back seat of the car. The seat cushion 11 is formed by: supporting, on a cushion frame (not shown) formed of a metal or a synthetic resin, a cushion pad (not shown) formed of foam such as soft polyurethane foam; and covering the cushion pad by a skin material (not shown).

The seat back 12 in the present embodiment can form backrests, for two persons, of the back seat of the car. Out of the backrests for two persons, the backrest on the left side is partially formed by the armrest 20 in an accommodated state where the armrest 20 is raised upward. The seat back 12 has a front surface in which a recess 13 for accommodating the armrest 20 is formed. The recess 13 is opened also in a left side surface of the seat back 12.

The armrest support structure 30 is provided on the left side of a lower end part of the armrest 20 accommodated in the recess 13. The lower end part of the armrest 20 is supported on the seat back 12 so as to be rotatable about a rotation shaft 31 which is provided to the armrest support structure 30 and which extends in the leftward-rightward direction. A state where the armrest 20 is rotated about the rotation shaft 31 so as to be tilted frontward as indicated by an alternate long and two short dashes line in FIG. 2 is an in-use state of the armrest 20. On the armrest 20 in the in-use state, an arm of a person seated on the right side on the seat 10 and an arm of a person seated on a seat separately provided on the left side relative to the seat 10 can be placed.

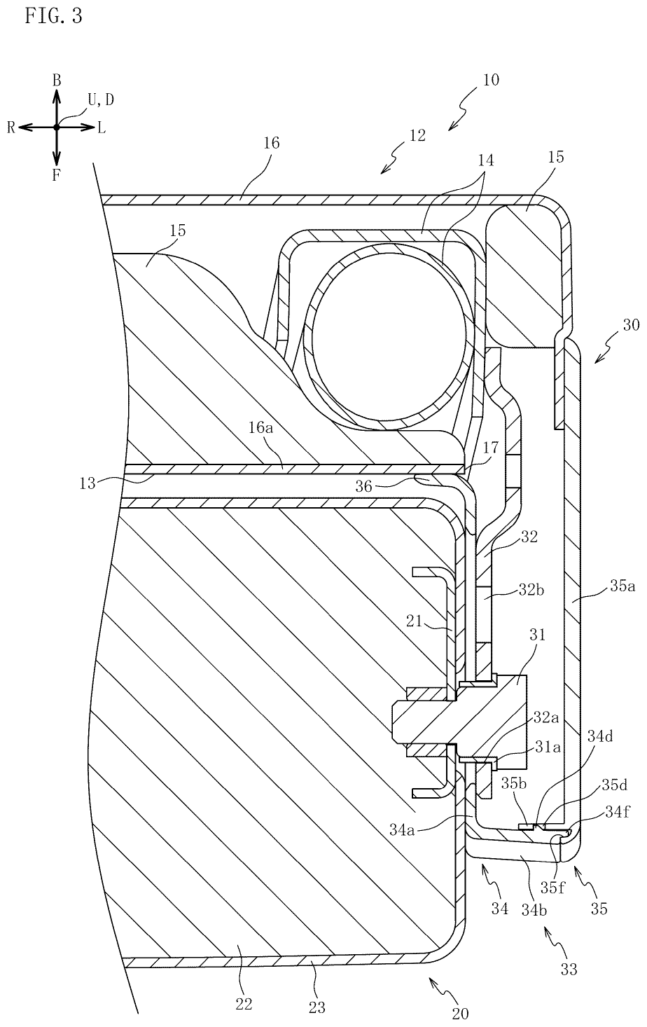

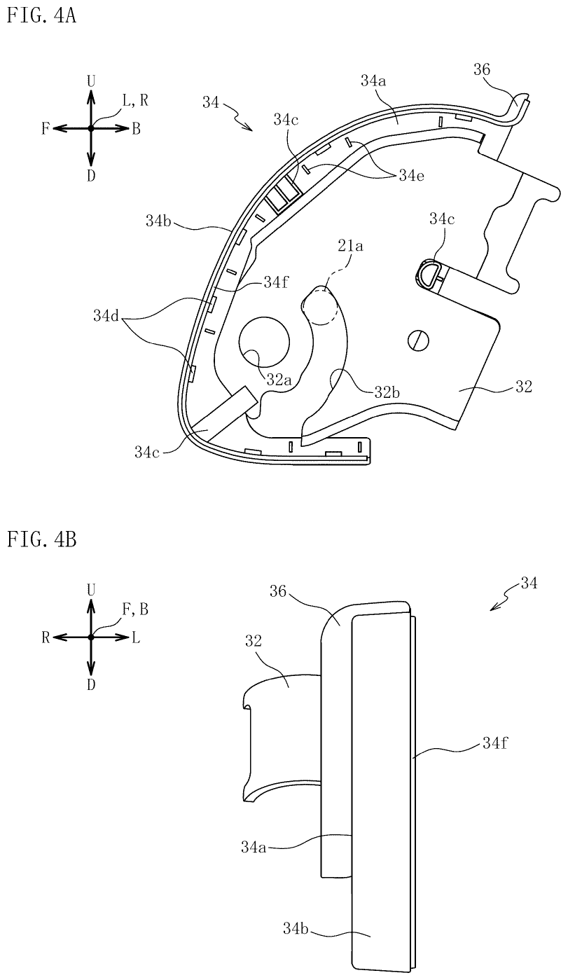

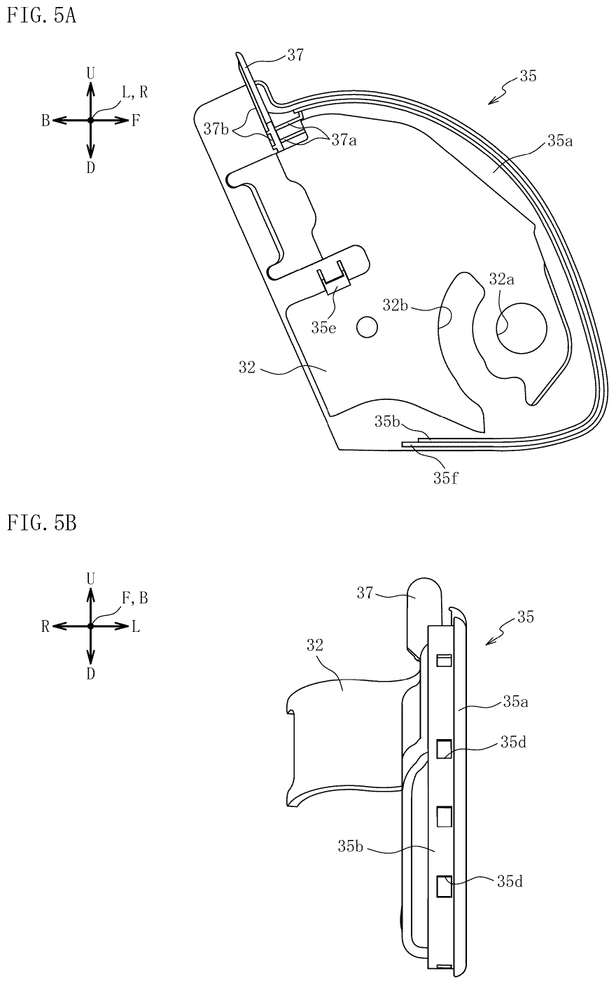

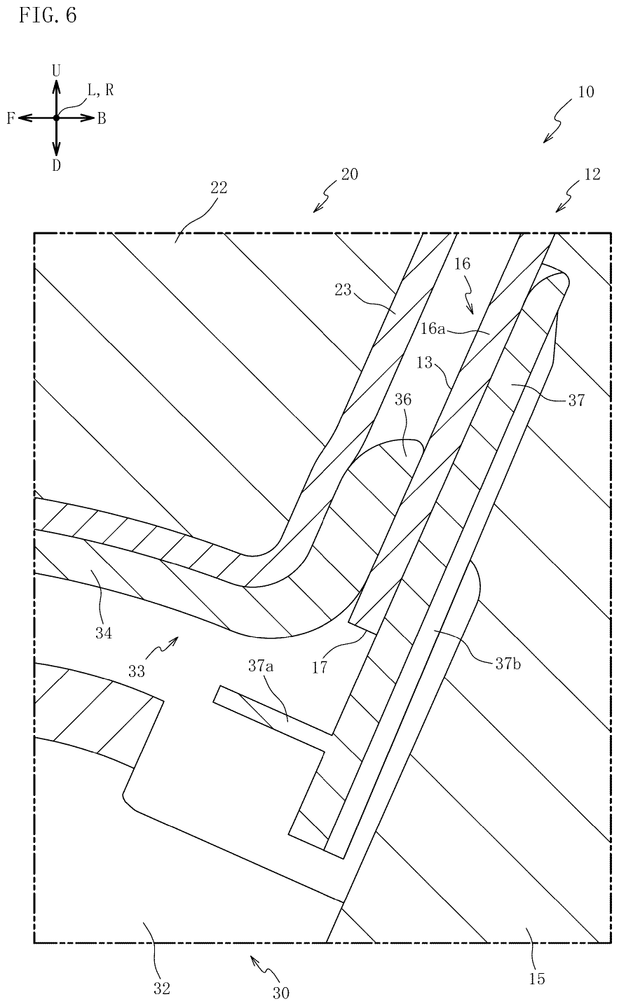

Next, the armrest support structure 30 will be described in further detail with reference to FIG. 3 to FIG. 6. FIG. 3 is a schematic cross-sectional view of, the seat back 12, the armrest 20, and the armrest support structure 30, taken at a line III-III in FIG. 2. FIG. 4A is a side view of a hinge bracket 32 and an inner member 34. FIG. 4B is a front view of the hinge bracket 32 and the inner member 34. FIG. 5A is a side view of the hinge bracket 32 and an outer member 35. FIG. 5B is a front view of the hinge bracket 32 and the outer member 35. FIG. 6 is a schematic cross-sectional view of, the seat back 12, the armrest 20, and the armrest support structure 30, taken at a line VI-VI in FIG. 1.

As shown in FIG. 3, the seat back 12 is formed by: supporting, on a back frame 14 formed of a metal or a synthetic resin, a back pad 15 formed of foam such as soft polyurethane foam; and covering the back pad 15 by a skin material 16. Likewise, the armrest 20 is formed by: supporting, on a frame 21 formed of a metal or a synthetic resin, a pad 22 formed of foam such as soft polyurethane foam; and covering the pad 22 by a skin material 23.

The armrest support structure 30 includes: the hinge bracket 32 attached to a left side part of the back frame 14; the rotation shaft 31 connecting the frame 21 of the armrest 20 to the hinge bracket 32; and a hinge cover 33 mounted to the hinge bracket 32 so as to cover the hinge bracket 32.

As shown in FIG. 3 and FIG. 4A, the hinge bracket 32 is implemented by a metal sheet extending in the upward-downward direction and the frontward-backward direction. The hinge bracket 32 has a back part joined to the back frame 14 through welding or the like, and the majority of the hinge bracket 32 protrudes frontward from an opening 17 provided in the skin material 16 of the seat back 12. The skin material 16 has a front surface 16a which faces the back of a seated person, the front surface 16a has a bottom surface defining the recess 13, and the opening 17 is provided in this bottom surface. More specifically, the opening 17 is provided at a corner on the left side of the bottom surface (front surface 16a) defining the recess 13.

The hinge bracket 32 has a front end part protruding from the opening 17, and a through-hole 32a is formed so as to penetrate this part in the leftward-rightward direction. A bolt forming the rotation shaft 31 is inserted into the through-hole 32a with a bearing 31a therebetween. Furthermore, a nut is fitted to the bolt having penetrated the frame 21, whereby the frame 21 is rotatably attached to the hinge bracket 32.

In the hinge bracket 32, a guiding groove 32b having an arc shape around the rotation shaft 31 is formed on the back side relative to the through-hole 32a so as to penetrate the hinge bracket 32. A protruding pin 21a protruding leftward from the frame 21 of the armrest 20 is inserted into the guiding groove 32b. The protruding pin 21a is moved in the guiding groove 32b in association with rotation of the armrest 20. When this movement brings the protruding pin 21a into contact with an upper end defining the guiding groove 32b, further rotation of the armrest 20 is restricted, whereby the armrest 20 is kept in the in-use state.

The hinge cover 33 is a member formed of a synthetic resin and covering the hinge bracket 32 so as to: hide, from a seated person or the like, such a rotating mechanism composed of the rotation shaft 31, the protruding pin 21a, the guiding groove 32b, and the like; and prevent a hand, a finger, or the like of the seated person from being caught in the rotating mechanism. The hinge cover 33 covers substantially the entirety of a part, of the hinge bracket 32, that protrudes from the opening 17 and that excludes a rotation route of the protruding pin 21a and the rotation shaft 31 between the hinge bracket 32 and the frame 21. The hinge cover 33 includes: an inner member 34 covering the armrest 20 side (the right side, i.e., the inner side) of the hinge bracket 32; and an outer member 35 covering a side (the left side, i.e., the outer side), of the hinge bracket 32, opposite to the armrest 20.

As shown in FIG. 4A and FIG. 4B, the inner member 34 includes: an inner body portion 34a having the shape of a flat sheet and located on the inner side relative to the hinge bracket 32; an outer peripheral edge portion 34b protruding in the form of a flange leftward (toward the outer member 35) from the peripheral edge of the inner body portion 34a; and a plurality of positioning portions 34c which position the inner member 34 with respect to the hinge bracket 32.

The plurality of positioning portions 34c protrude from the inner body portion 34a and the outer peripheral edge portion 34b toward the hinge bracket 32 so as to be in contact with the upper and lower sides, the front and back sides, and the right side of the hinge bracket 32. The shapes and the positions of these plurality of positioning portions 34c may be changed as appropriate as long as the inner member 34 can be positioned.

However, one positioning portion 34c on the front side (in the present embodiment, one positioning portion 34c on the lower front side) among the plurality of positioning portions 34c is preferably configured to sandwich the front edge of the hinge bracket 32 between the one positioning portion 34c and the inner body portion 34a. Here, the inner member 34 mounted so as to cover the hinge bracket 32 is further mounted to the outer member 35, to be fixed to the hinge bracket 32. Even before this fixation, the above positioning portion 34c for sandwiching the front edge of the hinge bracket 32 makes it possible to inhibit the inner member 34 from shifting rightward or falling off.

The outer peripheral edge portion 34b is a portion protruding leftward from the upper edge, the front edge, and the lower edge of the inner body portion 34a so as to cover the periphery, of the hinge bracket 32, that excludes the back side (opening 17 side). A plurality of fitting claws 34d protrude from an inner surface side (hinge bracket 32 side) of the outer peripheral edge portion 34b. Each of the fitting claws 34d is formed in the shape of a wedge such that the protrusion amount thereof decreases toward the left side (see FIG. 3). In addition, a plurality of restriction portions 34e are provided at positions that are away from the outer peripheral edge portion 34b toward the hinge bracket 32 by amounts equivalent to the maximum protrusion amounts of the fitting claws 34d.

An obverse flange 36 is integrally formed with the inner member 34. The obverse flange 36 protrudes in the form of a flange upward from the back edge on the upper side of the outer peripheral edge portion 34b and rightward from the back edge of the inner body portion 34a. As shown in FIG. 3 and FIG. 6, the obverse flange 36 is pressed against the front surface 16a of the skin material 16 at the periphery of the opening 17. The obverse flange 36 can make it less likely for a seated person or the like to see the opening 17 itself or see the internal structure of the seat back 12 through the opening 17.

As shown in FIG. 5A and FIG. 5B, the outer member 35 includes: an outer body portion 35a having the shape of a flat sheet and located on the outer side relative to the hinge bracket 32; and an inner peripheral edge portion 35b protruding in the form of a flange rightward (toward the inner member 34) from a vicinity of the peripheral edge of the outer body portion 35a. The inner peripheral edge portion 35b is a portion protruding rightward from vicinities of the upper edge, the front edge, and the lower edge (positions slightly away from the respective edges) of the outer body portion 35a so as to cover the periphery, of the hinge bracket 32, that excludes the back side (opening 17 side). The inner peripheral edge portion 35b has a plurality of fitting holes 35d formed so as to penetrate therethrough.

As shown in FIG. 3, FIG. 4A, and FIG. 5A, in order to mount the outer member 35 so as to cover the outer side of the hinge bracket 32, the inner peripheral edge portion 35b is inserted between the outer peripheral edge portion 34b and the restriction portions 34e of the inner member 34 mounted to the hinge bracket 32. Furthermore, the plurality of fitting claws 34d are fitted into the plurality of respective fitting holes 35d. By thus fitting and fixing the inner peripheral edge portion 35b to the outer peripheral edge portion 34b, both the inner member 34 and the outer member 35 are fixed to the hinge bracket 32.

Furthermore, at the time of the fitting and fixation therebetween, a linear protrusion 34f provided on an end of the outer peripheral edge portion 34b is fitted to a linear groove 35f provided between the inner peripheral edge portion 35b and the peripheral edge of the outer body portion 35a. Consequently, the joint between the inner member 34 and the outer member 35 can be made less likely to be shifted, whereby a beautiful appearance of the hinge cover 33 can be improved.

In addition, the outer member 35 has a back part having, in the upward-downward direction, a center (a position away from the inner peripheral edge portion 35b) provided with a claw 35e which is caught on the inner side of the hinge bracket 32. Consequently, the outer member 35 can be, at the position thereof away from the inner peripheral edge portion 35b, inhibited from coming off the hinge bracket 32.

Description will be given with reference back to FIG. 5A and FIG. 5B. The outer member 35 has an upper part from which a reverse flange 37 protrudes upward. The reverse flange 37 is formed of a sheet material substantially perpendicular to the outer body portion 35a and is integrally formed with the outer member 35. The reverse flange 37 extends, on the back side relative to the back edge on the upper side of the inner peripheral edge portion 35b, from an inner surface (on the hinge bracket 32 side) of the outer body portion 35a to the upper right side in a front view and, from the upper right side, further extends straight upward in the front view. The reverse flange 37 has an upper end having a semi-circular shape in the front view.

At the corner between a front surface of the reverse flange 37 and the inner surface of the outer body portion 35a, two reinforcement sheets 37a perpendicularly connecting these surfaces are provided. Consequently, the reverse flange 37 can be made less likely to be bent backward with respect to the outer member 35. In addition, the reverse flange 37 has a back surface from which two reinforcement ribs 37b continuous over substantially the entire length in the upward-downward direction of the back surface protrude. Consequently, the rigidity of the reverse flange 37 can be ensured. The number of the reinforcement sheets 37a may be one or may be three or more. Likewise, the number of the reinforcement ribs 37b may be one or may be three or more.

As shown in FIG. 3, the outer body portion 35a at a part thereof on the back side relative to the reverse flange 37 is superposed on and pressed against the obverse side of a left side surface of the skin material 16 at a part thereof on the back side relative to the opening 17. This part of the outer body portion 35a can make it less likely for a seated person or the like to see the opening 17 itself or see the internal structure of the seat back 12 through the opening 17.

As shown in FIG. 6, in a state where the hinge cover 33 is mounted and fixed to the hinge bracket 32, the reverse flange 37 is inserted into the opening 17, extends along the reverse side of the front surface 16a of the skin material 16, and is disposed between the reverse side of the front surface 16a and the back pad 15. Consequently, when, for example, an arm of a seated person placed on the armrest 20 in the in-use state is pressed against the seat back 12, the reverse flange 37 can restrict recession of the skin material 16 on the upper side of the hinge cover 33.

As a result, it is possible to inhibit: an inconvenience that recession of the skin material 16 leads to, for example, a shift of the overlap between the outer body portion 35a and the left side surface of the skin material 16 so that the internal structure of the seat back 12 becomes visible through the opening 17 and so that a wrinkle is formed at the joint between the outer body portion 35a and the left side surface of the skin material 16; and other inconveniences. That is, the reverse flange 37 can ensure the appearance quality of the seat back 12 on the upper side of the hinge cover 33. In addition, the reverse flange 37 can inhibit a garment or the like from being, when the shape of the recessed part of the skin material 16 has returned to the original shape thereof, caught between the previously recessed part and the upper side of the hinge cover 33.

The reinforcement sheets 37a and the reinforcement ribs 37b make it less likely for the reverse flange 37 to be deformed, whereby recession of the skin material 16 due to deformation of the reverse flange 37 can be suppressed. As a result, the appearance quality at the joint between the hinge cover 33 and the skin material 16 can be further improved, and it can be made less likely for a garment or the like to be caught between the hinge cover 33 and the skin material 16.

The skin material 16 is sandwiched between the obverse flange 36 and the reverse flange 37 on the upper side of the hinge cover 33, whereby frontward and backward movements of the sandwiched part of the skin material 16 are restricted. Therefore, a change in the appearance due to the frontward and backward movements can be suppressed, whereby the appearance quality of the seat back 12 can be improved on the upper side of the hinge cover 33. The case where the skin material 16 is sandwiched between the obverse flange 36 and the reverse flange 37 may be: a case where the skin material 16 is held and fixed therebetween; or a case where the skin material 16 is loosely sandwiched therebetween to such an extent as not to be held and fixed therebetween.

The reverse flange 37 protrudes further upward than the obverse flange 36, whereby the reverse flange 37 can restrict recession of the skin material 16 on the upper side relative to the obverse flange 36. As a result, the appearance quality at the joint between the obverse flange 36 and the skin material 16 can be further improved, and it can be made less likely for a garment or the like to be caught between the obverse flange 36 and the skin material 16.

Here, in order to mount the inner member 34 of the hinge cover 33 to the hinge bracket 32, it is necessary to bring the plurality of positioning portions 34c into contact with the hinge bracket 32 while inserting the inner member 34 into a narrow gap between the inner side of the hinge bracket 32 and the armrest 20. The insertion into the narrow gap leads to decrease in the degree of freedom in the manner of movement of the inner member 34 during the mounting.

Thus, in a case where the reverse flange 37 is provided to such an inner member 34, it is difficult to move the inner member 34 so as to further insert the reverse flange 37 into the opening 17 during the mounting. In addition, insertion needs to be performed such that the front edge of the hinge bracket 32 is sandwiched between the positioning portion 34c on the lower front side and the inner body portion 34a, and in this respect as well, the degree of freedom in the manner of movement of the inner member 34 is decreased, and it is difficult to perform mounting while inserting the reverse flange 37 provided to the inner member 34 into the opening 17.

Meanwhile, in the present embodiment, the reverse flange 37 is provided to the outer member 35. Since the armrest 20 is absent on the outer side of the hinge bracket 32 to which the outer member 35 is mounted, the degree of freedom in the manner of movement of the outer member 35 during the mounting can be ensured. Consequently, the outer member 35 can be easily mounted to the hinge bracket 32 by: inserting the reverse flange 37 into the opening 17; and then covering the hinge bracket 32 by the outer member 35 from the outer side. Therefore, even though the reverse flange 37 is present, it can be made easy to mount the hinge cover 33 to the hinge bracket 32.

Furthermore, with the reverse flange 37 being provided to the outer member 35, the obverse flange 36 is provided to the inner member 34. That is, the obverse flange 36 and the reverse flange 37 are provided to different members, whereby it can be made easy to sandwich the skin material 16 between these flanges during mounting of the hinge cover 33.

In addition, when the outer member 35 is mounted to the hinge bracket 32, the outer member 35 is easily shifted backward with respect to the inner member 34 mounted to the hinge bracket 32, owing to work for inserting the reverse flange 37 into the opening 17. Consequently, the inner peripheral edge portion 35b of the outer member 35 is easily located on the back side relative to the outer peripheral edge portion 34b of the inner member 34. The inner peripheral edge portion 35b only has to be fitted and fixed to the outer peripheral edge portion 34b with this positional relationship being maintained, whereby workability in the fitting and fixation can be improved.

Although the present invention has been described above based on the above embodiment, it can be easily understood that the present invention is not limited to the above embodiment at all, and various modifications and improvements may be made without departing from the gist of the present invention.

Although a case where the armrest support structure 30 is provided on the left side of the seat back 12 and the armrest 20 has been described in the above embodiment, the present invention is not necessarily limited to this case. For example, the left and right sides of the seat 10 may be inverted such that the armrest support structure 30 is provided on the right side of the seat back 12 and the armrest 20. Also, without limitation to a case where the armrest 20 in the accommodated state forms a part of the backrest, the armrest support structure 30 according to the present invention is applicable to a case where the armrest 20 does not form a part of the backrest. The seat 10 including the armrest support structure 30 is not limited to a back seat of a car and may be a front seat of a car, a seat mounted in a vehicle other than a car, or a seat that is not mounted in a vehicle.

Although a case where the hinge bracket 32 and the hinge cover 33 are respectively formed of a metal and a synthetic resin has been described in the above embodiment, the present invention is not necessarily limited to this case. For example, the hinge bracket 32 may be formed of a synthetic resin. Meanwhile, the hinge cover 33 may be formed of a metal.

Although a case where the hinge cover 33 is composed of two members which are the inner member 34 and the outer member 35 has been described in the above embodiment, the present invention is not necessarily limited to this case. The hinge cover 33 may be composed of one member or may be composed of three or more members. At least one of the inner member 34 and the outer member 35 in the above embodiment may be divided into a plurality of pieces such that the hinge cover 33 is composed of three or more members. Also, without limitation to a case where the obverse flange 36 and the reverse flange 37 are integrally formed with the hinge cover 33 (the inner member 34 and the outer member 35), the obverse flange 36 and the reverse flange 37 may be components separate from the hinge cover 33.

The manner of mounting the hinge cover 33 to the hinge bracket 32 is not limited to the manner described in the above embodiment and may be changed as appropriate. For example, the hinge cover 33 may be configured such that: the inner member 34 is fastened and fixed to the hinge bracket 32 with a bolt or the like; and then the outer member 35 is fastened and fixed to this inner member 34 with a bolt or the like.

### DESCRIPTION OF REFERENCE NUMERALS

10 seat
12 seat back
14 back frame
16 skin material
16a front surface
17 opening
20 armrest
30 armrest support structure
32 hinge bracket
33 hinge cover
34 inner member
34b outer peripheral edge portion
35 outer member
35b inner peripheral edge portion
36 obverse flange
37 reverse flange

What is claimed is:

1. An armrest support structure which allows an armrest to be rotatably supported with respect to a seat back of a seat, the armrest support structure comprising:
a hinge bracket configured to be attached to a side part of a back frame of the seat back, the hinge bracket having a part that allows the armrest to be rotatably supported thereon and that is configured to protrude frontward from an opening provided in a front surface of a skin material of the seat back;
a hinge cover configured to be mounted to the hinge bracket protruding from the opening, so as to cover the hinge bracket; and
a reverse flange protruding upward from an upper part of the hinge cover, the reverse flange being configured to be inserted into the opening and extend along a reverse side of the front surface of the skin material.

2. The armrest support structure according to claim 1, further comprising
an obverse flange protruding upward from the upper part of the hinge cover, the obverse flange being configured to be superposed on an obverse side of the front surface of the skin material with the skin material being sandwiched between the obverse flange and the reverse flange.

3. The armrest support structure according to claim 2, wherein the reverse flange protrudes further upward than the obverse flange.

4. The armrest support structure according to claim 1, wherein
the hinge cover includes
an inner member configured to cover the armrest side of the hinge bracket and
an outer member configured to cover a side, of the hinge bracket, opposite to the armrest, and
the reverse flange protrudes upward from an upper part of the outer member.

5. The armrest support structure according to claim 4, further comprising
an obverse flange protruding upward from an upper part of the inner member, the obverse flange being configured to be superposed on an obverse side of the front surface of the skin material with the skin material being sandwiched between the obverse flange and the reverse flange.

6. The armrest support structure according to claim 4, wherein
the inner member includes an outer peripheral edge portion configured to protrude toward the outer member so as to cover a periphery of the hinge bracket, and
the outer member includes an inner peripheral edge portion configured to protrude toward the inner member, the inner peripheral edge portion being configured to be superposed on the hinge bracket side of the outer peripheral edge portion and be fitted and fixed to the outer peripheral edge portion.
